(19) United States
(12) Patent Application Publication
(10) Pub. No.: US 2026/0109006 A1
(43) Pub. Date: Apr. 23, 2026

(54) WORKPIECE HOLDING MECHANISM, EXPOSURE APPARATUS, AND WORKPIECE HOLDING METHOD

(71) Applicant: Ushio Denki Kabushiki Kaisha, Tokyo (JP)

(72) Inventors: Takeshi MINOBE, Tokyo (JP); Changhwan PARK, Tokyo (JP)

(73) Assignee: Ushio Denki Kabushiki Kaisha, Tokyo (JP)

(21) Appl. No.: 19/361,688

(22) Filed: Oct. 17, 2025

(30) Foreign Application Priority Data
Oct. 22, 2024 (JP) 2024-185734

(51) Int. Cl. B25B 5/14

(52) U.S. Cl. CPC B25B 5/145

(57) ABSTRACT

A workpiece holding mechanism includes: a stage on which a plate-like workpiece is placed; a pressing mechanism that includes a plurality of protrusions provided independently from the stage and disposed to come into contact with a circumferential edge portion of the workpiece from a front side of the workpiece, the front side being opposite to the stage, and presses the circumferential edge portion of the workpiece against the stage by the plurality of protrusions; and a clamp mechanism that includes a clamp portion provided to the stage and configured to come into contact with the circumferential edge portion of the workpiece from the front side of the workpiece at a location between the protrusions without interfering with the plurality of protrusions, and presses the circumferential edge portion of the workpiece against the stage by the clamp portion.

### CROSS REFERENCE TO RELATED APPLICATIONS

This application claims the benefit of Japanese Priority Patent Application JP 2024-185734 filed Oct. 22, 2024, the entire contents of which are incorporated herein by reference.

### BACKGROUND

The present invention relates to a workpiece holding mechanism that holds a workpiece, an exposure apparatus, and a workpiece holding method.

The technologies of holding a workpiece on a stage have been developed from the past. For example, Japanese Patent Application Laid-open No. 2013-210432 discloses a workpiece installing apparatus that transports and fixes a workpiece to an installation base that vacuum-suctions a workpiece. In this apparatus, a workpiece is transported with its both ends in the width direction being clamped so as to pinch the workpiece, and the workpiece is then disposed on the installation base while keeping that state. When the workpiece is disposed on the installation base, the four sides of the workpiece are clamped by clamps provided to the installation base. This makes it possible to transport the workpiece while keeping flatness and also fix the workpiece to the installation base while ensuring flatness.

### SUMMARY

In general, it is assumed that a workpiece subjected to an exposure process is a member having warpage due to processing of attaching a plurality of substrates to each other, heat treatment, and the like. If such warpage is left when the workpiece is held on the stage, for example, this causes a possibility that the clamp does not reach the workpiece. Additionally, if the workpiece is vacuum-suctioned, a gap may occur due to the warpage of the workpiece, which may make it difficult to properly vacuum-suction the workpiece. Therefore, there is a need for a technology capable of reliably holding a workpiece with respect to a stage.

In view of the circumstances as described above, it is desirable to provide a workpiece holding mechanism, an exposure apparatus, and a workpiece holding method that are capable of reliably holding a workpiece with respect to a stage.

According to an embodiment of the present invention, there is provided a workpiece holding mechanism including a stage, a pressing mechanism, and a clamp mechanism.

On the stage, a plate-like workpiece is placed.

The pressing mechanism includes a plurality of protrusions provided independently from the stage and disposed to come into contact with a circumferential edge portion of the workpiece from a front side of the workpiece, the front side being opposite to the stage, and presses the circumferential edge portion of the workpiece against the stage by the plurality of protrusions.

The clamp mechanism includes a clamp portion provided to the stage and configured to come into contact with the circumferential edge portion of the workpiece from the front side of the workpiece at a location between the protrusions without interfering with the plurality of protrusions, and presses the circumferential edge portion of the workpiece against the stage by the clamp portion.

In this workpiece holding mechanism, the circumferential edge portion of the workpiece is pressed against the stage from the front side by the plurality of protrusions. Additionally, the circumferential edge portion of the workpiece is pressed against the stage from the front side by the clamp portion at a location between the protrusions without interfering with the plurality of protrusions. Thus, for example, pressing the workpiece by the plurality of protrusions eliminates the warpage of the workpiece. Hence, the clamp portion can press the workpiece in a state where the warpage of the workpiece is eliminated. As a result, it is possible to reliably hold the workpiece with respect to the stage.

The plurality of protrusions may be columnar members having tip surfaces that come into contact with the front side of the workpiece or suction pads that suction the workpiece from the front side of the workpiece.

The plurality of protrusions may be the columnar members. In this case, the columnar members may each include a recessed structure provided to each tip surface.

The plurality of protrusions may be the suction pads. In this case, the pressing mechanism may be a handler that suctions and transports the workpiece by the suction pads.

The clamp portion may be a plate-like member that includes notches formed to surround the plurality of protrusions, or a comb-like member that presses the circumferential edge portion of the workpiece by rods at locations between the plurality of protrusions.

The stage may vacuum-suction the workpiece.

The stage may include a seal member that is disposed to overlap with the circumferential edge portion of the workpiece. In this case, the plurality of protrusions may press the circumferential edge portion of the workpiece against the stage from immediately above the seal member.

The pressing mechanism may execute a first holding operation of pressing the circumferential edge portion of the workpiece against the stage by the plurality of protrusions. In this case, the clamp mechanism may execute a second holding operation of pressing the circumferential edge portion of the workpiece against the stage by the clamp portion with the first holding operation being executed.

The pressing mechanism may separate the plurality of protrusions from the workpiece with the second holding operation being executed.

The clamp mechanism may include a contact component that constitutes at least a portion of the clamp portion, the portion coming into contact with the workpiece, a mount portion on which the contact component is detachably mounted, and a tentative fixing portion for clamp that tentatively fixes the contact component and the mount portion by a magnet.

The pressing mechanism may include a support frame that supports the plurality of protrusions, and a frame drive section that drives the support frame such that the plurality of protrusions press the workpiece.

The frame drive section may include a plate spring portion in which a restoring force acts in a direction orthogonal to the workpiece, and may be connected to the support frame via the plate spring portion.

The support frame may include a plurality of unit frames that support the plurality of protrusions in a row along the circumferential edge portion of the workpiece, and a mount frame on which the plurality of unit frames are detachably mounted.

The support frame may include a tentative fixing portion for protrusion that tentatively fixes the plurality of unit frames and the mount frame by a magnet.

An exposure apparatus according to an embodiment of the present invention includes a workpiece holding mechanism and an exposure section.

The workpiece holding mechanism includes a stage on which a plate-like workpiece is placed, a pressing mechanism that includes a plurality of protrusions provided independently from the stage and disposed to come into contact with a circumferential edge portion of the workpiece from a front side of the workpiece, the front side being opposite to the stage, and presses the circumferential edge portion of the workpiece against the stage by the plurality of protrusions, and a clamp mechanism that includes a clamp portion provided to the stage and configured to come into contact with the circumferential edge portion of the workpiece from the front side of the workpiece at a location between the protrusions without interfering with the plurality of protrusions, and presses the circumferential edge portion of the workpiece against the stage by the clamp portion.

The exposure section exposes a pattern onto the workpiece held by the stage.

A workpiece holding method according to an embodiment of the present invention is a workpiece holding method of holding a plate-like workpiece on a stage on which the workpiece is placed, the method including: executing a first holding operation of pressing a circumferential edge portion of the workpiece against the stage by a plurality of protrusions provided independently from the stage and disposed to come into contact with the circumferential edge portion of the workpiece from a front side of the workpiece, the front side being opposite to the stage; and executing a second holding operation of pressing the circumferential edge portion of the workpiece against the stage by a clamp portion provided to the stage and configured to come into contact with the circumferential edge portion of the workpiece from the front side of the workpiece at a location between the protrusions without interfering with the plurality of protrusions with the first holding operation being executed.

As described above, according to the present invention, it is possible to reliably hold a workpiece with respect to a stage. Note that the effects described herein are not necessarily limited and may be any effect described in the present disclosure.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic view showing a configuration example of an exposure apparatus including a workpiece holding mechanism according to a first embodiment of the present invention;

FIG. 2A is a perspective view showing a configuration example of the workpiece holding mechanism;

FIG. 2B is a perspective view showing a configuration example of the workpiece holding mechanism;

FIG. 3 is a perspective view showing a configuration example of a warpage correction mechanism;

FIG. 4 is a cross-sectional view of the warpage correction mechanism shown in FIG. 3;

FIG. 5 is a perspective view showing a configuration example of a pusher;

FIG. 6 is a plan view showing a configuration example of a workpiece stage provided with a clamp mechanism;

FIG. 7 is a schematic cross-sectional view showing a configuration example of the clamp mechanism;

FIG. 8 is a flowchart showing an example of an operation example of the workpiece holding mechanism;

FIG. 9 is a schematic view showing an operation example of the workpiece holding mechanism;

FIG. 10 is a partial perspective view of the workpiece holding mechanism during execution of a holding operation; and

FIG. 11 is a schematic view showing a configuration example of a workpiece holding mechanism according to a second embodiment of the present invention.

### DETAILED DESCRIPTION OF EMBODIMENTS

Hereinafter, embodiments according to the present invention will be described with reference to the drawings.

### First Embodiment

### [Configuration of Exposure Apparatus]

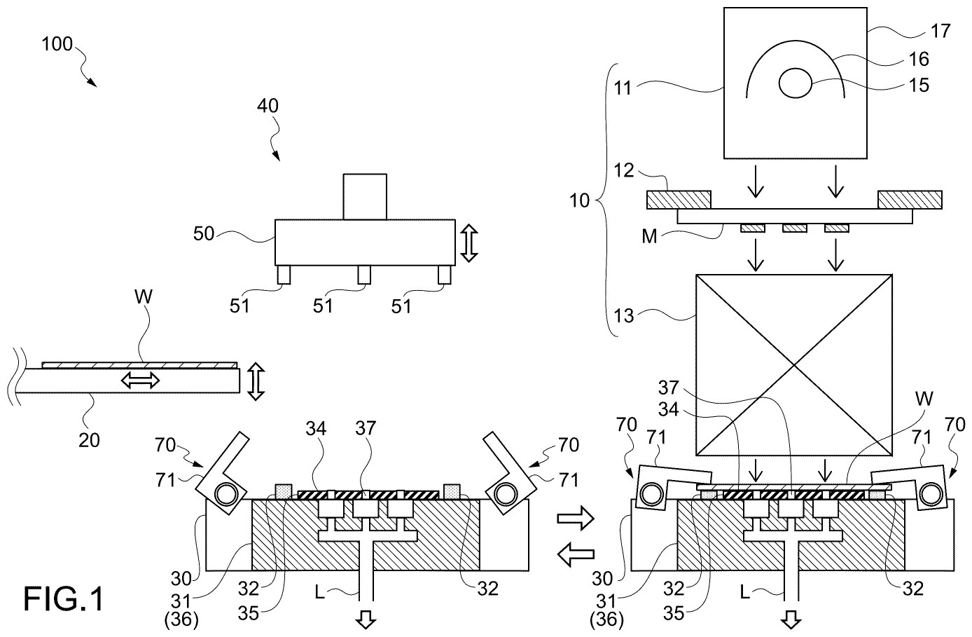

FIG. 1 is a schematic view showing a configuration example of an exposure apparatus including a workpiece holding mechanism according to a first embodiment of the present invention. An exposure apparatus 100 is an apparatus that exposes a plate-like workpiece W to light. The exposure apparatus 100 includes an exposure section 10, a workpiece handler 20, a workpiece stage 30, and a workpiece holding mechanism 40.

The workpiece W is, for example, an organic substrate or a glass substrate and is placed on the workpiece stage 30. Hereinafter, in the workpiece W, the side facing toward the workpiece stage 30 will be described as a back side of the workpiece W, and the side opposite from the workpiece stage 30 will be described as a front side of the workpiece W. The main surface on the front side of the workpiece W is an exposure surface on which exposure is to be performed. The exposure surface of the workpiece W loaded into the exposure apparatus 100 is coated with a sensitive material such as photoresist.

As the workpiece W, for example, a rectangular substrate in which each side has a length of approximately 500 mm is used. In addition, a relatively thin workpiece W having a thickness of approximately 0.2 mm can also be used. As a matter of course, the shape, planar size, and thickness of the workpiece W are not limited to the above example. In this embodiment, the case where the planar shape of the workpiece W is rectangular will be mainly described, but the present invention is also applicable to a workpiece W having a circular shape or a polygonal shape.

In the following, directions orthogonal to each other on the plane (a suction surface 34 to be described later) along the workpiece stage 30 on which the plate-like workpiece W is placed will be referred to as an X direction and a Y direction. In addition, a direction orthogonal to the XY plane will be descried as a Z direction. FIG. 1 is a schematic view of the exposure apparatus 100 as viewed from the Y direction. The XY plane is, for example, set as a horizontal plane, and the Z direction is set as a vertical direction. Note that the orientation in which the exposure apparatus 100 is used, or the like is not limited and can be discretionally set.

The exposure section 10 exposes a pattern onto the workpiece W held on the workpiece stage 30. As shown in FIG. 1, the exposure section 10 includes a light irradiation section 11, a mask M, a mask stage 12, and a projection optical system 13.

The light irradiation section 11 emits exposure light. The light irradiation section 11 includes a lamp 15, a mirror 16, and a lamp house 17. The lamp 15 is a light source for exposure that emits exposure light including ultraviolet rays. The mirror 16 reflects the exposure light emitted from the lamp 15 in a predetermined emission direction. The lamp house 17 is an enclosure that houses the lamp 15 and the mirror 16. Here, a case will be described, in which the light source of the light irradiation section 11 is the lamp 15; however, examples of the light source to be used may include a light-emitting diode (LED) and a laser light source. Additionally, the wavelength and bandwidth of the exposure light are also not limited.

A pattern such as a circuit pattern to be exposed (transferred) onto the workpiece W is formed on the mask M. The mask stage 12 holds the mask, onto which the pattern has been formed, on an optical path of the exposure light. The projection optical system 13 projects the exposure light that has been transmitted through the mask M onto the flat plate-like workpiece W. For example, the projection optical system 13 is configured as a reduction optical system in which the pattern of the mask M is reduced in size to form an image on the surface of the workpiece W. Note that in this embodiment the case where the mask M and the mask stage 12 are included in the exposure section 10 will be described, but the present invention is also applicable to a case where the mask M and the mask stage 12 are not included. For example, the present invention may also be applied to, for example, a direct imaging (DI) exposure apparatus that directly draws a wiring pattern by scanning of laser light.

The workpiece handler 20 is a transport apparatus that transports the workpiece W to the workpiece stage 30. In this embodiment, the workpiece handler 20 is configured to support the workpiece W from the back side. In this case, the workpiece W transported by the workpiece handler 20 is placed on the workpiece stage 30 via a delivery pin (not shown) or the like, the delivery pin being provided to the workpiece stage 30 and having a raising and lowering function. In addition to the above, the specific configuration of the workpiece handler 20, the method of delivering the workpiece W, and the like are not limited, and any mechanism capable of placing the workpiece W on the workpiece stage 30 may be used.

The workpiece stage 30 is a vacuum suction stage that vacuum-suctions the workpiece W. The workpiece stage 30 includes a suction section 31 and a seal member 32. The suction section 31 includes a suction plate 35 having a suction surface 34 on which the workpiece W is vacuum-suctioned, and a base 36 that supports the suction plate 35. The workpiece W is placed on the workpiece stage 30 with the back surface facing the suction surface 34. The suction surface 34 (suction plate 35) includes a plurality of vacuum suction holes 37. Additionally, each vacuum suction hole 37 is connected to piping L for vacuum evacuation via a void formed in the base 36. For example, when the workpiece W is vacuum-suctioned, the piping L is connected to a vacuum pump. Further, when the vacuum suction for the workpiece W is released, gas (air etc.) for breaking the vacuum atmosphere is supplied to the piping L.

The seal member 32 is a seal member (vacuum seal) made of an elastic body. The seal member 32 is disposed around the suction surface 34 such that the workpiece W hides at least part of the seal member 32 in plan view when the suction surface 34 is viewed from above. In other words, the seal member 32 is disposed at a position surrounding the suction surface 34 and below the workpiece W (below a circumferential edge portion 41 to be described later) and is configured to come into contact with the back surface of the workpiece W. Providing the seal member 32 makes it less likely to generate a gap on the back surface side of the workpiece W and makes it possible to suppress the leakage of the vacuum atmosphere.

In this embodiment, the workpiece stage 30 is connected to a moving mechanism (not shown) and moves between a delivery position and an exposure position for the workpiece W. At the delivery position, the workpiece W is delivered between the workpiece handler 20 and the workpiece stage 30. At the exposure position, the workpiece W is disposed immediately below the projection optical system 13. For the moving mechanism, for example, a linear surface motor using magnetic levitation, a mechanism that moves the workpiece stage 30 along a rail, and a mechanism that holds and moves the workpiece stage 30 using an arm or the like are used. Other configurations of the moving mechanism are not limited.

The workpiece holding mechanism 40 includes the workpiece stage 30 described above, a warpage correction mechanism 50, and a clamp mechanism 70. The warpage correction mechanism 50 is a mechanism that corrects warpage of the workpiece W on the workpiece stage 30 by a plurality of pushers 51. The clamp mechanism 70 is a mechanism that clamps the workpiece W on the workpiece stage 30 by a clamp portion 71. In the workpiece holding mechanism 40, using the plurality of pushers 51 of the warpage correction mechanism and the clamp portion 71 of the clamp mechanism 70, a holding operation of holding the workpiece W on the workpiece stage 30 is performed. In this embodiment, the workpiece stage 30 corresponds to a stage, and the warpage correction mechanism 50 corresponds to a pressing mechanism. In the following, the general outline of the workpiece holding mechanism 40 will be described.

### [General Outline of Workpiece Holding Mechanism]

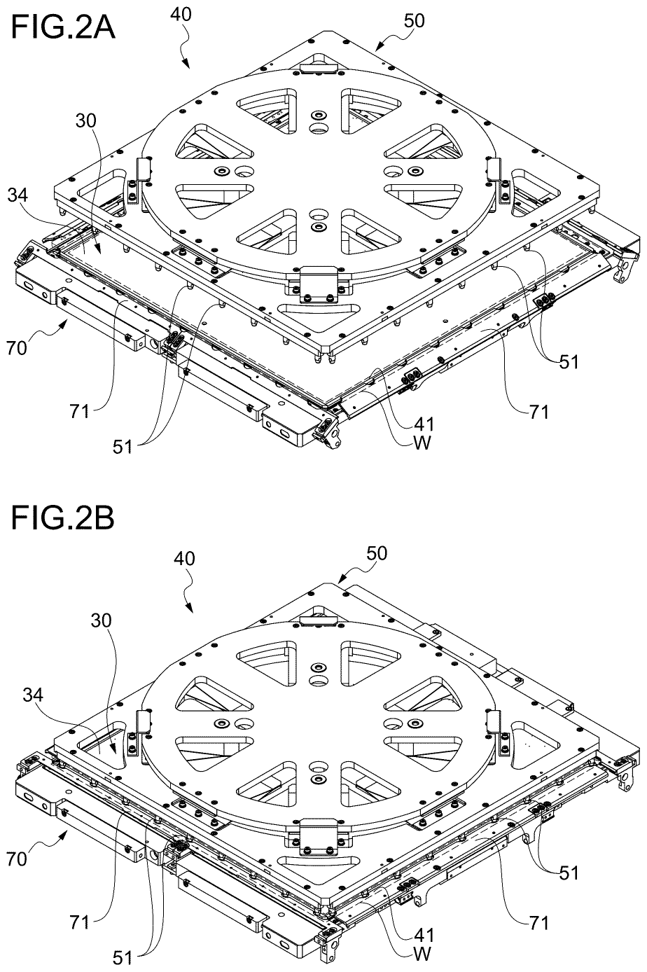

FIGS. 2A and 2B are perspective views each showing a configuration example of the workpiece holding mechanism 40. FIG. 2A shows the workpiece holding mechanism 40 before the holding operation is performed, in which the warpage correction mechanism 50 is in a raised state of being disposed apart from the workpiece stage 30, and the clamp mechanism 70 is in an open state (unclamped state) where the clamp portion 71 is opened. Additionally, FIG. 2B shows the workpiece holding mechanism 40 during the holding operation, in which the warpage correction mechanism 50 is in a lowered state of being lowered toward the workpiece stage 30, and the clamp mechanism 70 is in a closed state (clamped state) where the clamp portion 71 is closed.

As shown in FIG. 2A, the plurality of pushers 51 provided to the warpage correction mechanism 50 are members (protrusions) that protrude in a convex shape from the surface, of the warpage correction mechanism 50, facing the workpiece W. The plurality of pushers 51 are provided independently from the workpiece stage 30 and disposed so as to come into contact with a circumferential edge portion 41 of the workpiece W from the front side of the workpiece W, which is the opposite side from the workpiece stage 30. In this embodiment, the plurality of pushers 51 corresponds to a plurality of protrusions.

Here, “provided independently from the workpiece stage 30” means that being disposed without moving together with the workpiece stage 30. In this embodiment, the whole of the warpage correction mechanism 50 including the plurality of pushers 51 is configured independently from the workpiece stage 30 and moves relative to the workpiece stage 30.

Additionally, in the present disclosure, the circumferential edge portion 41 of the workpiece W is an annular surface region that comes into contact with an outer circumferential end of the workpiece W. FIGS. 2A and 2B schematically show the circumferential edge portion 41 of the workpiece W by a dotted line region. For example, in the workpiece W, a region between a product region in which a circuit and the like constituting a product are formed (in the exposure apparatus 100, the workpiece W is an exposure region) and the outer circumferential end of the workpiece W is the circumferential edge portion 41 of the workpiece W. Therefore, on the front side of the workpiece W, the circumferential edge portion 41 can be referred to as a region that does not affect exposure or the like even if other members come into contact with that region. The width of the circumferential edge portion 41 of the workpiece W (an interval between the product region and the outer circumferential end) is, for example, approximately several millimeters, but it may be discretionally set.

As shown in FIG. 2B, when the holding operation is performed, the warpage correction mechanism 50 lowers the portion that supports the plurality of pushers 51 to the workpiece stage 30. Thus, the circumferential edge portion 41 of the workpiece W is pushed by the plurality of pushers 51 from the front side and pressed against the workpiece stage 30. In such a manner, the warpage correction mechanism 50 presses the circumferential edge portion 41 of the workpiece W against the workpiece stage 30 by the plurality of pushers 51.

The clamp portion 71 of the clamp mechanism 70 is provided to the workpiece stage 30 and configured to come into contact with the circumferential edge portion 41 of the workpiece W from the front side of the workpiece W at a location between the pushers 51 without interfering with the plurality of pushers 51. In other words, the clamp portion 71 is configured to have a shape capable of pressing the circumferential edge portion 41 of the workpiece W without colliding with the plurality of pushers 51 even in a state in which the circumferential edge portion 41 of the workpiece W is pressed against the workpiece stage 30 by the plurality of pushers 51. The clamp mechanism 70 presses the circumferential edge portion 41 of the workpiece W against the workpiece stage 30 by the clamp portion 71 configured as described above.

As shown in FIG. 2B, this makes it possible for the clamp mechanism 70 to close the clamp portion 71 without colliding with the pushers even in a state where the warpage correction mechanism 50 is lowered, and possible to properly clamp the circumferential edge portion 41 of the workpiece W. In other words, in the workpiece holding mechanism 40, the plurality of pushers 51 of the warpage correction mechanism 50 and the clamp portion 71 of the clamp mechanism 70 can simultaneously press the circumferential edge portion 41 of the workpiece W against the workpiece stage 30 without interfering with each other. Such a configuration makes it possible to clamp the workpiece W by the clamp mechanism 70, for example, in a state where the warpage of the workpiece W is corrected using the warpage correction mechanism 50. This makes it possible to reliably hold the workpiece W with respect to the workpiece stage 30.

### [Configuration of Warpage Correction Mechanism]

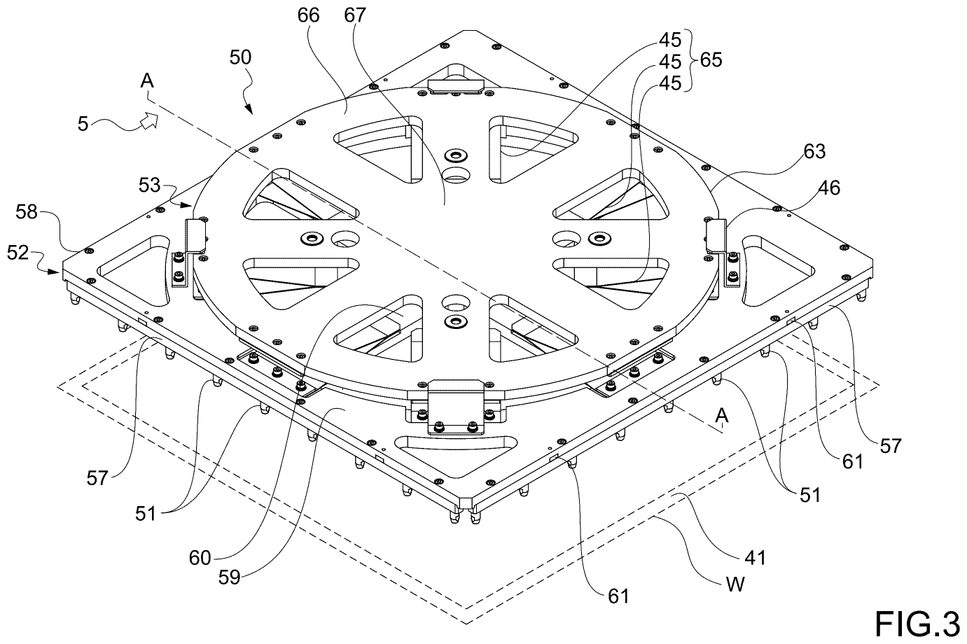

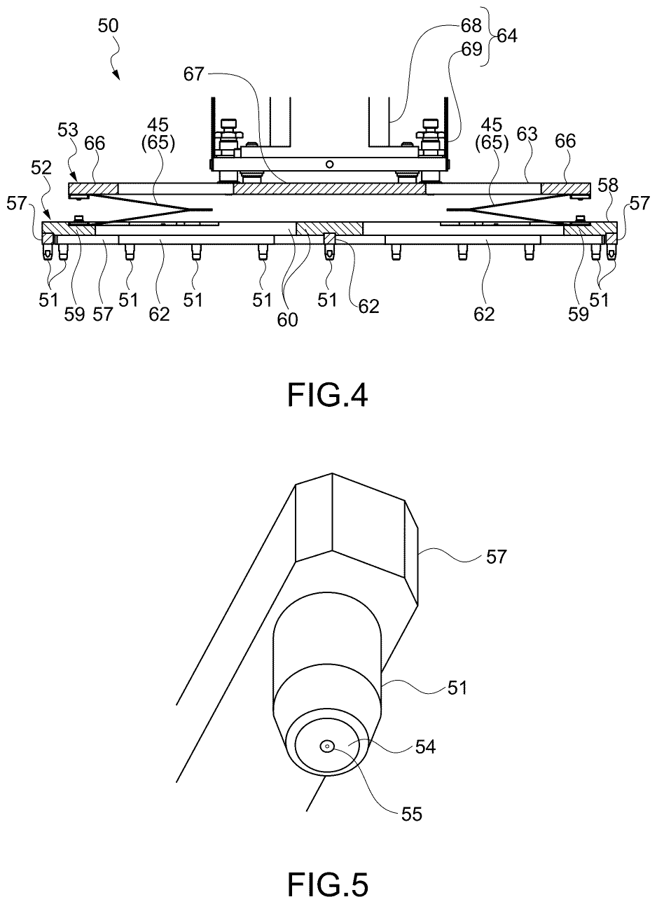

FIG. 3 is a perspective view showing a configuration example of the warpage correction mechanism. FIG. 4 is a cross-sectional view of the warpage correction mechanism shown in FIG. 3. FIG. 4 shows a cross-section of the warpage correction mechanism 50 taken along the line AA shown in FIG. 3 and viewed from the direction of an arrow 5, and also shows the cross-sections of the members as portions with hatching. FIG. 5 is a perspective view showing a configuration example of the pusher. The warpage correction mechanism 50 includes the plurality of pushers 51 described above, a support frame 52, and a frame drive section 53.

First, a configuration of the pusher 51 will be described with reference to FIG. 5. FIG. 5 illustrates the state of one pusher 51 as viewed from below. In this embodiment, the plurality of pushers 51 are columnar members each having a tip surface 54 that comes into contact with the front side of the workpiece W. Thus, the pusher 51 comes into contact with the workpiece W at the tip surface 54, and thus a force to press the workpiece W against the workpiece stage 30 is dispersed. This makes it possible to avoid breakage of the workpiece W, for example.

In the example shown in FIG. 5, the pusher 51 is configured as a cylindrical member with a tapered side surface, which is formed to be tapered toward its one end. An end surface connected to the tapered side surface is the tip surface 54. In addition to the above, the shape of the pusher 51 is not limited, and for example, any columnar member with a surface that comes into contact with the front side of the workpiece W may be used. The plurality of pushers 51 are fixed to a circumferential unit frame 57, which will be described later, or the like, such that the tip surfaces 54 face downward.

Additionally, each pusher 51 (columnar member) includes a recessed structure 55 that is provided to the tip surface 54. The recessed structure 55 is a structural portion in which the tip surface 54 is recessed. Here, a mortar-shaped recess is formed as the recessed structure 55. Note that a recess, a slit, or the like having any shape may be used as the recessed structure 55.

For example, if the contact operation between the pusher 51 and the workpiece W is repeated, the pusher 51 may be abraded or deformed by being pressured. In this regard, providing the recessed structure 55 to the tip surface 54 that comes into contact with the front side of the workpiece W makes it possible to easily check the degree of wear (the degree of abrasion or the degree of crush) of the pusher 51 visually or by touch. This makes it possible to easily determine time for replacement of the pusher 51, etc., thereby improving maintainability.

For the material of the pusher 51, an elastic resin material or the like is used in order to prevent breakage or the like of the workpiece W. For example, a non-adhesive pusher 51 that easily detaches from the front side of the workpiece W can be configured using fluororesin. In addition, the material of the pusher 51 is not limited, and a plastic material, a rubber material, or the like may be used as appropriate.

Next, referring back to FIGS. 3 and 4, the support frame 52 will be described. The support frame 52 supports the plurality of pushers 51. The support frame 52 is a structural member disposed below the frame drive section 53, which will be described later, in the warpage correction mechanism 50, and is designed to fit the planar shape of the workpiece W (here, the rectangular workpiece W). The support frame 52 includes a plurality of circumferential unit frames 57 and a mount frame 58.

The plurality of circumferential unit frames 57 support the pushers 51 in rows along the circumferential edge portion 41 of the workpiece W. As shown in FIG. 3, in this embodiment, four circumferential unit frames 57 that linearly extend are provided to fit the four end sides of the rectangular workpiece W. Below each of the circumferential unit frames 57, a predetermined number of pushers 51 are disposed apart from each other in a row. In this embodiment, the circumferential unit frame 57 corresponds to a unit frame.

The mount frame 58 is a member that supports the plurality of circumferential unit frames 57. The plurality of circumferential unit frames 57 are detachably mounted on the mount frame 58. In this embodiment, the mount frame 58 is a rectangular plate member having the substantially same shape and size as the workpiece W.

The mount frame 58 shown in FIG. 3 includes an outer circumferential region 59 formed in a rectangular frame shape, and an inner region 60 formed in the shape of a cross along the X direction and the Y direction. The mount frame 58 is appropriately thinned out to leave the outer circumferential region 59 and the inner region 60. Further, as shown in FIGS. 3 and 4, steps into which the circumferential unit frames 57 are to be fitted are formed in a region on the lower side of the outer circumferential region 59, in which the circumferential unit frames 57 are to be mounted. Note that the shape or the like of the mount frame 58 is not limited and is appropriately configured, for example, so as to be capable of supporting each circumferential unit frame 57 or the like.

The plurality of circumferential unit frames 57 are fitted into the steps located on the lower side of the mount frame 58 along the four end sides (outer circumferential portion) of the mount frame 58 and fixed by screwing. Use of the circumferential unit frames 57 to unitize the plurality of pushers 51 in such a manner makes it possible to replace a predetermined number of pushers 51 arranged along the end sides of the workpiece W in units of row. This makes it possible to improve maintainability, for example, as compared to the case of replacing the pushers 51 one by one.

Additionally, in this embodiment, the support frame 52 includes a tentative fixing portion for pusher 61 that tentatively fixes the plurality of circumferential unit frames 57 and the mount frame 58 by magnets. In this embodiment, the tentative fixing portion for pusher 61 corresponds to a tentative fixing portion for protrusion.

The tentative fixing portion for pusher 61 includes a magnet provided to one of the circumferential unit frame 57 or the mount frame 58, and a magnet provided to the other one of them. Note that, instead of the configuration in which the magnets are provided to both the circumferential unit frame 57 and the mount frame 58, a magnet may be provided to one of the members and a ferromagnetic metal piece may be provided to the other one of the members. Additionally, the other member itself may be formed of a ferromagnetic metal. In the example shown in FIG. 3, magnets (or ferromagnetic metal pieces) embedded into the lower part of the outer circumferential region 59 of the mount frame 58 are illustrated as the tentative fixing portions for pusher 61.

If the tentative fixing portion for pusher 61 is provided, the circumferential unit frame 57 is temporarily fixed (tentatively fixed) to the mount frame 58. Hence, in the replacement of the circumferential unit frame 57, the circumferential unit frame 57 and the mount frame 58 can be attached by screwing or the like in the tentatively fixed state. This makes it possible to prevent the circumferential unit frame 57 from falling during replacement and to improve the efficiency of the replacement operation. Note that the circumferential unit frame 57 is not necessarily provided, and for example, the plurality of pushers 51 may be provided directly to the mount frame 58.

Hereinabove, the configuration in which the plurality of pushers 51 are provided to the circumferential unit frames 57 to press the circumferential edge portion 41 of the workpiece W against the workpiece stage 30 has been described. In addition to the above configuration, pushers 51 to press the workpiece W against the workpiece stage 30 in a region other than the circumferential edge portion 41 may be provided.

As shown in FIG. 4, the support frame 52 further includes a plurality of inner unit frames 62. The inner unit frames 62 are members that support the plurality of pushers 51 so as to come into contact with the workpiece W on the inner side relative to the circumferential edge portion 41 of the workpiece W. Each inner unit frame 62 supports the pushers 51 in a row, and is disposed in the shape of a cross below the inner region 60 of the mount frame 58.

For example, in the exposure for the workpiece W, it is assumed that the workpiece W is divided into four (2×2) exposure regions. In this case, the cross-shaped region that serves as the boundary of the exposure regions is a region where no exposure is performed, and thus the pushers 51 can be caused to come into contact therewith. Each pusher 51 provided to the inner unit frames 62 presses the workpiece W against the workpiece stage 30 in the cross-shaped region. This makes it possible to satisfactorily cause the workpiece W to come into close contact with the workpiece stage 30. In addition to the above, the pushers 51 can be disposed to come into contact with any position other than the boundary of the exposure regions as long as the position is a contactable position that may be allowed to come into contact with the workpiece W.

The frame drive section 53 drives the support frame 52 such that the plurality of pushers 51 press the workpiece W. The frame drive section 53 is connected above the support frame 52 (mount frame 58) and moves the entire support frame 52 in the Z direction. The frame drive section 53 includes a drive frame 63, a slide mechanism 64, and a plate spring portion 65. Note that in FIG. 3 the slide mechanism 64 is omitted.

As shown in FIG. 3, the drive frame 63 is a plate member having a substantially circular planar shape and is disposed above the mount frame 58. The drive frame 63 shown in FIG. 3 includes an outer circumferential region 66 formed in a circular frame, and an inner region 67 in which frames extending radially at 45° intervals from the center portion toward the outer circumferential region 66 are formed. Additionally, openings for thinning out are formed between the frames of the inner region 67.

Additionally, as shown in FIG. 4, the slide mechanism 64 includes a slider 68, a protective frame 69 that surrounds the slider 68, and a drive section that drives the slider 68 (not shown). The slider 68 and the protective frame 69 are connected from above to the inner region 67 of the drive frame 63. Additionally, the upper portion of the slider 68 is connected to the drive section. The drive section is fixed to a predetermined support member and slides the slider 68 along the up-down direction (Z direction). A linear actuator using, for example, compressed air is used as the slider 68 and the drive section, but other mechanisms such as electric actuators may also be used. Further, the slide mechanism 64 is controlled, for example, by a control apparatus that controls the operation of the entire exposure apparatus 100.

The plate spring portion 65 includes a plurality of plate springs 45 and is configured such that a restoring force acts in a direction orthogonal to the workpiece W (in the Z direction). Additionally, the plate spring portion 65 is a member that connects the drive frame 63 and the mount frame 58 to each other. In other words, the frame drive section 53 is connected to the support frame 52 via the plate spring portion 65.

In this embodiment, a plurality of pairs of plate springs 45, each of which is a combination of two plate springs 45, are provided between the drive frame 63 and the mount frame 58. As shown in FIG. 4, each pair of plate springs 45 is formed by vertically overlapping the rectangular plate springs 45 on each other and bonding and fixing each other at their one ends to be bent such that the other ends of the respective plate springs 45 are spaced apart from each other with a predetermined interval. The other end of the plate spring 45 on the upper side is fixed to the lower surface of the outer circumferential region 66 of the drive frame 63, and the other end of the plate spring 45 on the lower side is fixed to the upper surface of the outer circumferential region 59 of the mount frame 58. In the example shown in FIG. 3, eight pairs of plate springs 45 are disposed along the eight frames radially extending from the center portion of the drive frame 63 such that their one ends bonded and fixed face the inner side.

The pairs of plate springs 45 are radially disposed in such a manner, which makes it possible to cause a restoring force to work in the Z direction between the drive frame 63 and the mount frame 58. Thus, for example, if the slide mechanism 64 is operated to press the workpiece W by the plurality of pushers 51, the workpiece W can be pressed by a force corresponding to the restoring force generated by the plate spring portion 65. In other words, the workpiece W is pressed by a force to restore the intervals narrowed by the pairs of plate springs 45.

For example, if the mount frame 58 is directly connected to the slide mechanism 64 without providing the plate spring portion 65, it is conceivable that the driving force of the slide mechanism 64 acts directly on the workpiece W. In this case, if the driving force is too large, the workpiece W may be broken. In contrast, providing the plate spring portion 65 makes it possible to avoid a situation in which an excessive force acts on the workpiece W. Additionally, the plate spring portion 65 is less likely to be twisted around the Z direction and can generate a restoring force in the Z direction without a guide. This makes it possible to avoid the generation of dust or the like originating from a guide portion.

Note that, in a state where the pushers 51 of the support frame 52 are separated from the workpiece W, it is assumed that the pairs of plate springs 45 are separated from each other more than in a natural state due to the self-weight of the support frame 52. Hence, as shown in FIG. 3, the support frame 52 (mount frame 58) is provided with hook portions 46 that hook the support frame 52 with respect to the drive frame 63 such that the interval between the support frame 52 and the drive frame 63 does not exceed a certain distance. This makes it possible to avoid a situation in which the restoring force of the plate spring portion 65 changes.

### [Configuration of Clamp Mechanism]

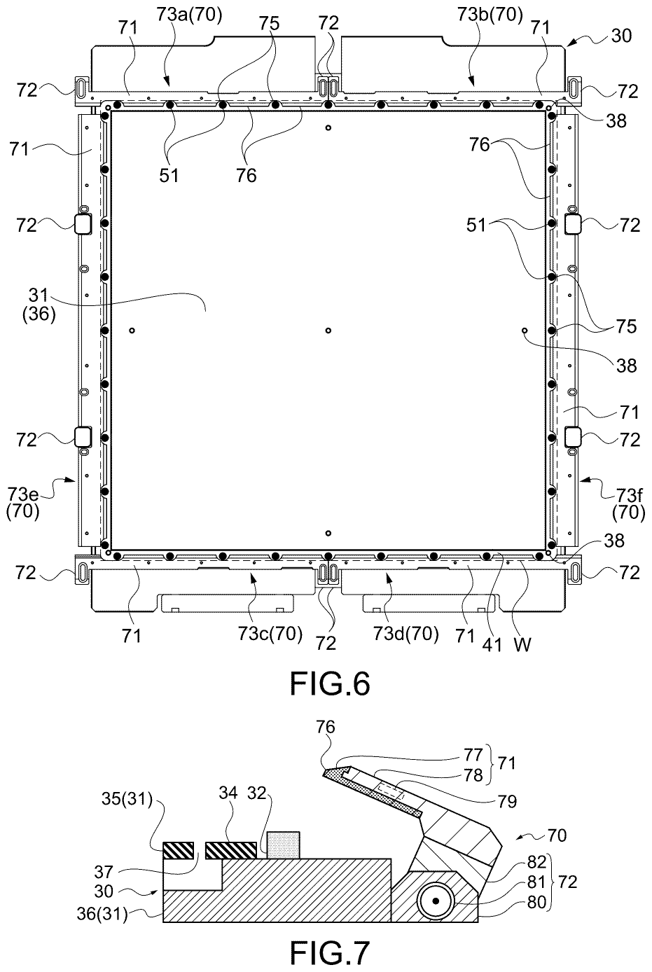

FIG. 6 is a plan view showing a configuration example of the workpiece stage including the clamp mechanism. FIG. 7 is a schematic cross-sectional view showing a configuration example of the clamp mechanism 70. The clamp mechanism 70 is, for example, a mechanism that clamps the workpiece W so as to prevent the workpiece W from peeling off by a reaction force of the warpage of the workpiece W during the vacuum suction for the workpiece W by the workpiece stage 30.

The workpiece stage 30 has the rectangular suction surface 34. The suction surface 34 includes the plurality of vacuum suction holes 37 (not shown) formed to vacuum-suction the workpiece W over the substantially entire region. Additionally, the suction surface 34 includes a plurality of through-holes for passing therethrough delivery pins for receiving the workpiece W from the workpiece handler 20. In this case, nine through-holes 38 are provided at the center of the suction surface 34, on the inner sides of the four vertices, and in the vicinity of the centers of the four end sides.

The clamp mechanism 70 includes the clamp portion 71 described above and a clamp drive section 72 that drives the clamp portion 71. The clamp mechanism 70 holds the workpiece W until just before the exposure process is performed or in the state where the clamp portion 71 is closed during the exposure process (clamped state). FIG. 6 is a view of the workpiece stage 30 in the clamped state as viewed from above in the Z direction, and schematically illustrates the workpiece W by a dotted line region. Additionally, the plurality of pushers 51 that come into contact with the circumferential edge portion 41 of the workpiece W are schematically illustrated by black-circle regions.

As shown in FIG. 6, the clamp mechanism 70 includes a plurality of clamp portions 71 and a plurality of clamp drive sections 72 provided to the clamp portions 71. In the following, a unit including a single clamp portion 71 and a clamp drive section 72 that drives the clamp portion 71 will be referred to as a clamp unit. Therefore, the clamp mechanism 70 includes a plurality of clamp units. Additionally, the clamp drive section 72 of each clamp unit is controlled by, for example, a control apparatus that controls the operation of the entire exposure apparatus 100.

In this embodiment, clamp units 73a to 73f are provided so as to surround the suction section 31 (base 36) of the workpiece stage 30 along the sides of the rectangular workpiece W. The clamp units 73a and 73b are adjacently disposed at the upper part of the suction section 31 in the figure, the clamp units 73c and 73d are adjacently disposed at the lower part of the suction section 31 in the figure, and the clamp units 73e and 73f are disposed at the left part and the right part of the suction section 31 in the figure, respectively.

The clamp units 73a and 73b (clamp units 73c and 73d) press a side of the upper part (a side of the lower part) of the workpiece W. In such a manner, the plurality of clamp units may be provided to one side of the workpiece W. The clamp units 73e and 73f individually press a side of the left part of the workpiece W and a side of the right part of the workpiece W, respectively. Note that the clamp units 73a and 73b (clamp units 73c and 73d) may be configured as a single clamp unit 73. The clamp units 73a to 73d are different from the clamp units 73e and 73f in the planar shape of the clamp portion 71 and the position of the clamp drive section 72, but basically have the same configuration.

As shown in FIG. 6, in this embodiment, the clamp portion 71 is a plate-like member in which notches 75 are each formed to surround the plurality of pushers 51. In this case, in order to press the rectangular workpiece W, a longitudinal plate-like member extending along the end side of the workpiece W is used as the clamp portion 71. In this case, notches 75 (here, semicircular notches) that the plurality of pushers 51 can enter are formed in the longitudinal end side of the clamp portion 71, the end side facing the inner side of the workpiece stage 30. In other words, it can also be described that the notches 75 of the clamp portion 71 are formed at portions that interfere with the plurality of pushers 51.

Additionally, the portions sandwiched by the adjacent notches 75 are contact ends 76 that come into contact with the workpiece W. This makes it possible for the clamp portion 71 to press regions, located between the adjacent pushers 51, in the circumferential edge portion 41 of the workpiece W, by the contact ends 76. Note that the shape or the like of the notches 75 is not limited, and for example, a rectangular notch, a triangular notch, and the like may be formed.

As shown in FIG. 7, the clamp mechanism 70 includes a contact component 77, a clamp main body 78, and a tentative fixing portion for clamp 79. The contact component 77 is a component constituting at least a portion of the clamp portion 71, which comes into contact with the workpiece W. Therefore, the contact component 77 can also be referred to as a component including a contact end 76. The contact component 77 that abuts on the workpiece W is made of a resin material such as fluororesin, rubber, or plastic in order to prevent the workpiece from being marked or scratched by clamping.

The clamp main body 78 is a structural member constituting the clamp portion 71, and the contact component 77 is detachably mounted on the clamp main body 78. In this embodiment, the clamp main body 78 corresponds to a mount portion. For example, a metal material such as aluminum or stainless steel is used as the clamp main body 78. Additionally, the notch 75 described above is provided over both the contact component 77 and the clamp main body 78.

The tentative fixing portion for clamp 79 tentatively fixes the contact component 77 and the clamp main body 78 by a magnet. A pair of magnets or a pair of a magnet and a ferromagnetic metal piece is used as the tentative fixing portion for clamp 79, and such a pair is separately provided to the contact component 77 and the mount portion, respectively. FIG. 7 schematically illustrates the tentative fixing portion for clamp 79, which is provided to the clamp main body 78, by a dotted line.

In this embodiment, the contact component 77 is a plate-like resin component provided from the tip to the lower surface of the clamp portion 71. Additionally, the clamp main body 78 is a plate-like structural member including a protrusion formed at the tip thereof. For example, the contact component 77 is fixed to the clamp main body 78 by screwing or the like in a state where a thick portion serving as the contact end 76 is fitted with the protrusion provided to the tip of the clamp main body 78. Note that the tentative fixing portion for clamp 79 is provided to the contact component 77 and the clamp main body 78. Hence, in the replacement of the contact component 77, a screwing operation or the like can be performed with the contact component 77 being temporarily fixed by the magnet.

Note that the entire clamp portion 71 may be configured to be replaceable. In this case, the clamp portion 71 itself is a contact component, and in the clamp drive section 72, a member on which the clamp portion 71 is mounted (rotary member 82 to be described later) is a mount portion. In such a case as well, providing the tentative fixing portion for clamp 79 to the clamp portion 71 and the rotary member 82 makes it possible to efficiently perform the operation of replacing the clamp portion 71.

In such a manner, a part or the whole of the clamp portion 71 may be replaceable. For example, it is assumed that a portion where the clamp portion 71 and the workpiece W abut on each other (the contact end 76 of the contact component 77) is worn (abraded) by repeating the clamp operation. In such a case, if the clamp mechanism 70 is configured as described above, it is possible to easily replace the contact component 77.

Additionally, in the past, a method of attaching a fluororesin seal or the like to the tip of the clamp has been used to prevent the workpiece W from being scratched. However, the contact end 76 of the clamp portion 71 provided with the notches 75 has a complicated shape, and the method of attaching a seal may increase the man-hours and time required for the maintenance operation. In contrast, use of the contact component 77, which is a block made of fluororesin or the like, makes it possible to greatly streamline the maintenance operation.

The clamp drive section 72 is a mechanism that mechanically moves the clamp portion 71 so as to press the workpiece W. As shown in FIG. 7, the clamp drive section 72 includes a seating 80, a shaft 81, and a rotary member 82. Additionally, the clamp drive section 72 includes a clamp drive mechanism (not shown) that moves the rotary member.

The seating 80 is a member that supports the shaft 81 and the rotary member 82 and is fixed to the circumference of the main body (base 36) of the workpiece stage 30. The seating 80 is fixed to the suction section 31 by screwing or the like. Alternatively, the seating 80 may be formed integrally with the base 36. Further, a through-hole into which the shaft 81 is fitted is formed in the seating 80.

The shaft 81 supports the rotary member 82 so as to be rotatable about a predetermined rotation axis O. The shaft 81 is, for example, a columnar member (typically, cylindrical member) that passes through both the seating 80 and the rotary member 82.

Additionally, for example, a columnar member configured to be fixed to one of the rotary member 82 and the seating 80 and to pass through the other one of the rotary member 82 and the seating 80 may be used as the shaft 81. Further, when the shaft 81 is formed, a bearing such as a ball bearing may be used.

The rotary member 82 is connected to the clamp main body 78 of the clamp portion 71 and rotates about the rotation axis O, thus driving the clamp portion 71. The operation of rotating the rotary member 82 is performed by the clamp drive mechanism. Note that the rotary member 82 is configured to rotate in the angle range set in advance. In FIG. 7, when the rotary member 82 rotates counterclockwise, the clamp portion 71 is closed, and when the rotary member 82 rotates clockwise, the clamp portion 71 is opened.

### [Operation of Workpiece Holding Mechanism]

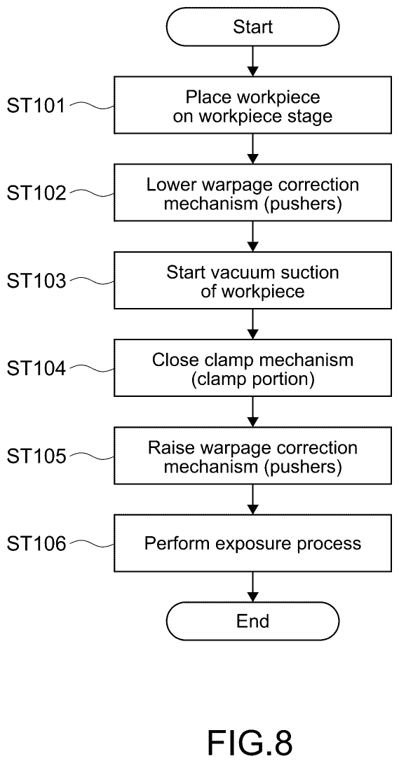

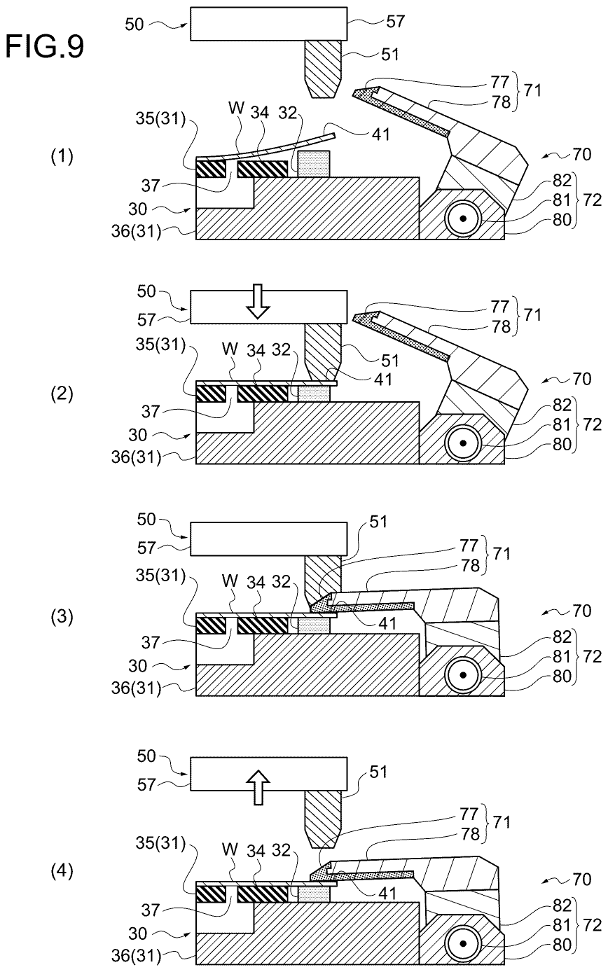

FIG. 8 is a flowchart showing an operation example of the workpiece holding mechanism 40. FIG. 9 is a schematic view showing an operation example of the workpiece holding mechanism 40. In the following, the basic operation of the workpiece holding mechanism 40 will be described mainly with reference to FIGS. 8 and 9.

As shown in FIG. 8, first, a workpiece W is placed on the workpiece stage 30 (Step 101). The operation of placing a workpiece W is performed, for example, in a state where the workpiece stage 30 is moved directly under the warpage correction mechanism 50 (see FIG. 2A). In this case, as shown in (1) of FIG. 9, the warpage correction mechanism 50 is in a raised state with the plurality of pushers 51 being raised by a certain distance from the workpiece stage 30. Additionally, the clamp mechanism 70 is in an open state in which the clamp portion 71 is open.

In this state, the workpiece handler 20 where the workpiece W is placed on the upper surface thereof is inserted between the workpiece stage 30 and the clamp mechanism 70, and the workpiece W is delivered to the delivery pin raised from the workpiece stage 30. When the workpiece W is delivered, the workpiece handler 20 is retracted. Subsequently, the delivery pin is lowered and the workpiece W is placed on the workpiece stage 30.

Note that as shown in (1) of FIG. 9, it is assumed that the workpiece W is warped at the time when the workpiece W is placed on the workpiece stage 30. The warpage of the workpiece W is caused, for example, by laminating multiple layers of substrates or heating the workpiece W in the process of previous steps. Additionally, the amount of warpage of the workpiece W (e.g., the amount by which the end side of the workpiece W is raised from a flat surface when the workpiece W is placed on the flat surface) varies depending on the thickness or planar size of the workpiece W, but is generally approximately 6 mm in a workpiece W with a planar size of approximately 500 mm. For example, assuming that the width of the circumferential edge portion 41 of the workpiece W, which can be contacted during clamping, is several millimeters, a relatively large warpage occurs.

Next, the warpage correction mechanism 50 (the plurality of pushers 51) is lowered (Step 102). Specifically, the slide mechanism 64 is driven to cause the entire warpage correction mechanism 50 to slide downward. Thus, first, the plurality of pushers 51 come into contact with the circumferential edge portion 41 of the workpiece W from the front side of the workpiece W. Further, when the plurality of pushers 51 are lowered, the circumferential edge portion 41 of the workpiece W is pushed by the plurality of pushers 51 to be pressed against the workpiece stage 30. In such a manner, the warpage correction mechanism 50 executes a first holding operation of pressing the circumferential edge portion 41 of the workpiece W against the workpiece stage 30 by the plurality of pushers 51. The first holding operation is continued until Step 105 to be described later is executed.

(2) of FIG. 9 shows a state of the first holding operation performed in Step 102. When the first holding operation is executed, the workpiece W is pressed against the workpiece stage 30, so that the warpage is corrected and the flatness of the workpiece W is improved. In such a manner, the first holding operation can also be referred to as a warpage correction operation of correcting the warpage of the workpiece W.

For example, even if the workpiece W has a relatively large amount of warpage as described above, the planar position of the workpiece W does not change significantly. In this regard, the warpage correction mechanism 50, which is a mechanism that pushes the workpiece W with the pushers 51 from immediately above, can easily bring the pushers 51 into contact with the circumferential edge portion 41 of the workpiece W even if the warpage of the workpiece W is large. This makes it possible to reliably execute the first holding operation of correcting the warpage of the workpiece W.

In this embodiment, the workpiece stage 30 is provided with the seal member 32. The seal member 32 is disposed so as to overlap with the circumferential edge portion 41 of the workpiece W. Additionally, the seal member 32 is configured such that its upper end is located higher than the suction surface 34. Therefore, the circumferential edge portion 41 of the workpiece W is pressed against the seal member 32 while the seal member 32 is compression-deformed. In this case, the plurality of pushers 51 press the circumferential edge portion 41 of the workpiece W against the workpiece stage 30 from immediately above the seal member 32. This makes it possible to cause the circumferential edge portion 41 of the workpiece W to reliably come into contact with the seal member 32, thereby efficiently performing vacuum evacuation.

Additionally, the seal member 32 is a member that comes into contact with the workpiece W from the back side, to be opposite to the pushers 51 that come into contact with the front side of the workpiece W. In such a manner, the plurality of pushers 51 favorably come into contact with the workpiece W from immediately above the member that comes into contact with the workpiece W from the back side. For example, if there is no member on the opposite side of the pushers 51, the workpiece W will be subjected to a localized force applied from the front side only, which may damage the workpiece W. On the other hand, if there is a member that comes into contact with the workpiece W on the opposite side of the pushers 51, the workpiece W will be subjected to forces from both the front side and the back side, which can satisfactorily avoid the damage of the workpiece W.

Additionally, as described with reference to FIG. 4 and the like, the warpage correction mechanism 50 is provided with the plate spring portion 65. Therefore, the force with which the pushers 51 press the workpiece W can be easily adjusted, for example, by the amount of crushing of the plate spring portion 65. For example, the warpage correction mechanism 50 is connected to a height adjustment mechanism that can adjust the height position of the entire warpage correction mechanism 50 including the slide mechanism 64. In this case, the amount of crushing of the plate spring portion 65, that is, the force with which the pushers 51 press the workpiece W, is adjusted by adjusting the height position of the drive frame 63 by the height adjustment mechanism while the amount of slide of the slide mechanism 64 is kept constant (e.g., the state being extended to the stroke end). Note that the method of adjusting the amount of crushing of the plate spring portion 65 is not limited, and for example, the amount of crushing may be adjusted by adjusting the amount of slide of the slide mechanism 64. In this embodiment, the force of the pushers 51 (amount of slide) is set such that the workpiece W becomes flat along the suction surface 34. This makes it possible to easily avoid a situation in which the workpiece W is pressed excessively and deformed, for example, even if the workpiece W is pressed against the seal member 32.

Note that the plurality of pushers 51 may come into contact with the workpiece W from immediately above the suction surface 34, rather than the seal member 32, or may come into contact with the workpiece W while protruding from the end side of the workpiece W. In addition, the contact positions of the pushers 51 at the circumferential edge portion 41 of the workpiece W are not limited and can be appropriately set, for example, such that the warpage of the workpiece W can be properly corrected.

Next, vacuum suction for the workpiece W is started by the workpiece stage 30 (Step 103). For example, the piping L for vacuum evacuation that is provided to the workpiece stage 30 is connected to the vacuum pump (see FIG. 1). Since the warpage of the workpiece W is corrected at the start of the vacuum suction, air leakage or the like due to the warpage of the workpiece W is avoided, and a proper suction state can be achieved in a short time. Additionally, vacuum suction is started before holding the workpiece W in the clamp portion 71, which can reduce the tact time. Note that the timing for starting vacuum suction is not limited, and for example, vacuum suction may be executed before Step 102 or after Step 104, which will be described later.

Next, the clamp mechanism 70 (clamp portion 71) is closed (Step 104). Specifically, the clamp portion 71 is driven by the clamp drive section 72 so as to come into contact with the workpiece W. During this operation, the warpage correction mechanism 50 is maintained in the lowered state (first holding operation), but the clamp portion 71 is configured not to interfere with the plurality of pushers 51, so that the workpiece W can be clamped without problems. As a result, the clamp portion 71 presses the circumferential edge portion 41 of the workpiece W against the workpiece stage 30 at locations between the pushers 51. In such a manner, the clamp mechanism 70 executes a second holding operation of pressing the circumferential edge portion 41 of the workpiece W against the workpiece stage 30 by the clamp portion 71 while the first holding operation is executed.

(3) of FIG. 9 shows a state of the second holding operation performed in Step 104. Here, the workpiece W is clamped by the clamp portion 71 disposed on the near side relative to the pusher 51 shown in the figure. At this time, the pusher 51 is surrounded by the notch 75 that is formed in the clamp portion 71 to avoid a collision with the pusher 51. In such a manner, the second holding operation is a clamp operation of clamping the workpiece W with the warpage of the workpiece W being corrected, and can also be referred to as an operation of pressing the workpiece W by both the plurality of pushers 51 and the clamp portion 71. This is the same state as that shown in FIG. 2B.

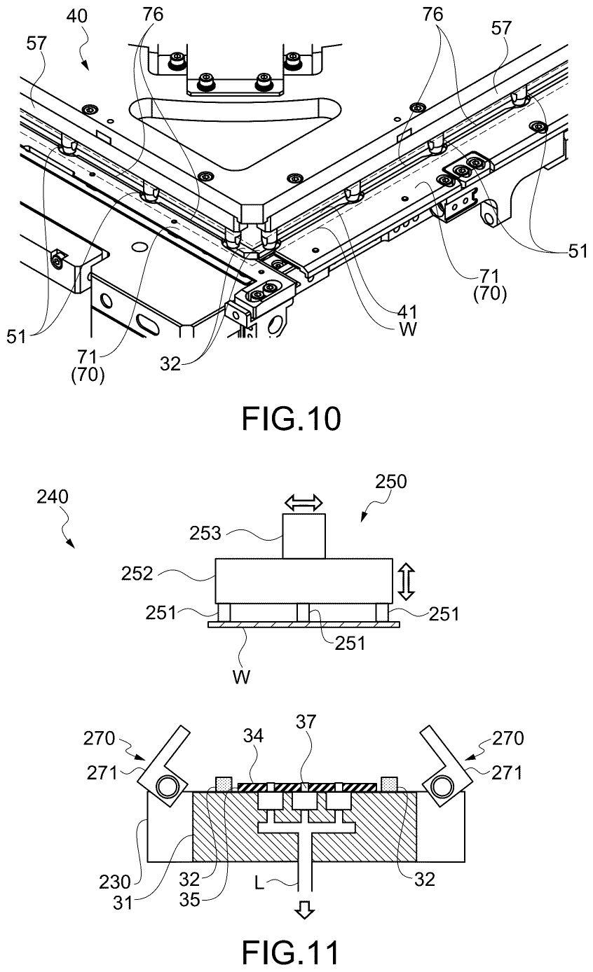

FIG. 10 is a partial perspective view of the workpiece holding mechanism during the holding operation. FIG. 10 is an enlarged view showing the state of the second holding operation shown in FIG. 2B. Here, the workpiece W is schematically illustrated by a dotted line region. When the second holding operation is performed, the contact end 76 of the clamp portion 71 enters a location between the pushers 51 adjacent to each other, and the workpiece W is clamped by the clamp portion 71 at the location between the pushers 51.

This can be referred to as, for example, a configuration that allows the plurality of pushers 51 to come into contact with the workpiece W at locations closer to the end side of the workpiece W than a line connecting the tips of the clamp portions 71 (contact ends 76). This makes it possible to ensure the contact area of the plurality of pushers 51 with respect to the workpiece W without protruding to the apparatus region (exposure region), and to properly press the workpiece W by the plurality of pushers 51. As a result, it is possible to achieve both the warpage correction operation by the plurality of pushers 51 and the clamp operation by the clamp portion 71.

Referring back to FIG. 8, when the second holding operation is executed, the warpage correction mechanism 50 (the plurality of pushers 51) is raised (Step 105). Specifically, the slide mechanism 64 is driven to cause the entire warpage correction mechanism 50 to slide upward. Thus, the plurality of pushers 51 are separated from the front side of the workpiece W, and the first holding operation is released. During this operation, the clamp portion 71 is kept in the closed state, and the second holding operation is maintained. In such a manner, the warpage correction mechanism 50 separates the plurality of pushers 51 from the workpiece W in the state where the second holding operation is executed.

As shown in (4) of FIG. 9, even when the plurality of pushers 51 are separated from the workpiece W, the workpiece W is clamped by the clamp portion 71, so that it is possible to avoid, for example, a situation in which the workpiece W peels off from the workpiece stage 30 by a reaction force of the workpiece W. Here, the reaction force of the workpiece W is the inner stress generated in the workpiece W due to the correction of the warpage.

In such a manner, if the clamp operation (second holding operation) by the clamp portion 71 is continued, even after the warpage correction mechanism 50 is retracted, the vacuum suction for the workpiece W can be continued properly and the flatness of the workpiece W can be maintained at a high level.

After the warpage correction mechanism 50 is raised, the exposure process by the exposure section 10 is executed (Step 106). For example, the workpiece stage 30 moves from the delivery position of the workpiece W to the exposure position, and the exposure process is started.

Note that the clamping by the clamp portion 71 may be continued during the exposure or may be released before the exposure. For example, for a workpiece W that is strongly warped, clamping is continued because there is a possibility that the workpiece W may peel off from the workpiece stage 30 during the exposure.

Additionally, for example, for a relatively thin workpiece W, clamping the workpiece W may reduce its flatness. In such a case, clamping may be released before the exposure. In such a manner, the exposure process can be achieved with high accuracy by appropriately selecting whether clamping is performed or not.

As described above, in the workpiece holding mechanism 40 according to this embodiment, the plurality of pushers 51 press the circumferential edge portion 41 of the workpiece W against the workpiece stage 30 from the front side. Additionally, the clamp portion 71 presses the circumferential edge portion 41 of the workpiece W against the workpiece stage 30 from the front side at the locations between the pushers 51 so as not to interfere with the plurality of pushers 51. This eliminates the warpage of the workpiece W, for example, by pressing the workpiece W by the plurality of pushers 51. Hence, the clamp portion 71 can press the workpiece W with the warpage of the workpiece W being eliminated. As a result, the workpiece W can be reliably held with respect to the workpiece stage 30.

In general, if the workpiece is warped, a gap is generated between the workpiece and the stage, which makes it difficult to vacuum-suction the workpiece properly. One possible method of eliminating the warpage of the workpiece is, for example, a method of pressing the workpiece with a clamp provided to the stage after the workpiece is placed on the stage. In this case, if the amount of warpage is relatively large, for example, there is a possibility that the tip of the clamp does not reach the workpiece W even if the workpiece W is attempted to be clamped on the stage, and the clamping fails.

For example, it is also conceivable to press the workpiece from above to correct the warpage, thus avoiding idle swinging of the clamp. A correction member for correcting warpage is caused to come into contact with the workpiece W on the outside of the product region as well as the clamp. On the other hand, it is assumed that a clamp with a long spatula shape, which is commonly used, interferes with the correction member because it clamps the workpiece W at a position as close as possible to the product region of the workpiece W. Additionally, if the correction member is provided inside the circumferential edge portion of the workpiece so as not to interfere with the clamp, there is a possibility that the workpiece cannot be satisfactorily corrected, for example, when the warpage of the workpiece is large, and thus clamping fails. Additionally, in many cases, the inside of the workpiece is a product region where contact is not allowed, including handling, etc., which makes it difficult to provide a correction member in the first place.

In this embodiment, the clamp portion 71 of the clamp mechanism 70 is configured to come into contact with the workpiece W at the locations between the pushers 51 without interfering with the plurality of pushers 51 provided to the warpage correction mechanism 50. This configuration makes it possible to hold the circumferential edge portion 41 of the workpiece W by the clamp portion 71 while pressing the circumferential edge portion 41 of the workpiece W from the front side by the plurality of pushers 51. In other words, it is possible to correct the warpage of the workpiece W and clamp the workpiece W to the workpiece stage 30 without causing the plurality of pushers 51 and the clamp portion 71 to interfere with each other. This makes it possible to reliably hold the workpiece W on the workpiece stage 30 by vacuum suction of the workpiece stage 30.

For example, after the warpage of the workpiece W is corrected by the plurality of pushers 51, it is possible to clamp the workpiece W by the clamp portion 71. This makes it possible to reliably clamp the workpiece W without idle swinging of the clamp portion 71 even if the amount of warpage of the workpiece W is large. Additionally, once the workpiece W is clamped, the workpiece W will not peel off from the workpiece stage 30 by the reaction force of the warpage of the workpiece W thereafter, and the vacuum suction for the workpiece W can be maintained properly. This makes it possible to achieve good exposure process.

Additionally, the plurality of pushers 51 and the clamp portion 71 can perform warpage correction and clamping by simply coming into contact with the circumferential edge portion 41 of the workpiece W. This makes it possible, for example, to take as large a product region (exposure region) as possible with respect to the workpiece W and to prevent the product region from being scratched, for example.

Additionally, in recent years, it has been necessary to improve the level of cleanliness in exposure apparatuses for printed circuit board, and a workpiece W stored in a hermetically sealed reservoir, called a front opening unified pod (FOUP), is transported to an exposure apparatus in some cases. In transporting the workpiece W from the FOUP to the exposure apparatus, it is structurally difficult to perform upper-surface suction transport in which a workpiece W is suctioned from the upper surface, and it is necessary to use robotic transport in which a workpiece W is suctioned from the lower surface. This configuration including the warpage correction mechanism 50 separately from the transport mechanism (the workpiece handler 20 shown in FIG. 1) is also applicable to the case where the workpiece W is robotically transported to the suction stage while the workpiece W is being suctioned from the lower surface. This makes it possible to achieve good exposure process while maintaining a high level of cleanliness.

### Second Embodiment

A workpiece holding mechanism according to a second embodiment of the present invention will be described. In the following, description of the part similar to the configuration and action in the workpiece holding mechanism 40 described in the above embodiment will be omitted or simplified.

FIG. 11 is a schematic view showing a configuration example of a workpiece holding mechanism according to a second embodiment. A workpiece holding mechanism 240 includes a workpiece stage 230, a clamp mechanism 270, and a handler 250. The handler 250 is a mechanism that transports a workpiece W to the workpiece stage 230 while suctioning the upper surface of the workpiece W. In this embodiment, the handler 250 also serves as a warpage correction mechanism that corrects warpage of the workpiece W on the workpiece stage 230. The workpiece stage 230 is configured to be similar to, for example, the workpiece stage 30 described with reference to FIG. 1.

The handler 250 includes a plurality of suction pads 251, a support frame 252, and a frame drive section 253. The plurality of suction pads 251 are disposed to face downward from the handler 250 and suction the workpiece W from the front side of the workpiece W. The contact position of the suction pads 251 is mainly set to a circumferential edge portion 41 of the workpiece W. The support frame 252 is a structural member that supports the plurality of suction pads 251, and is configured to be driven by the frame drive section 253 to be movable in each of the X, Y, and Z directions. In such a manner, the handler 250 is a mechanism that suctions the workpiece W by the suction pads 251 and transports the workpiece W. In this embodiment, the plurality of suction pads 251 correspond to a plurality of protrusions, and the handler 250 corresponds to a pressing mechanism.

The clamp mechanism 270 includes a clamp portion 271 that clamps the workpiece W onto the workpiece stage 230. The clamp portion 271 is provided to the workpiece stage 230 and configured to come into contact with the circumferential edge portion 41 of the workpiece W from the front side of the workpiece W at locations between the suction pads 251 without interfering with the plurality of suction pads 251.

Specifically, the clamp portion 271 is configured to have a shape capable of pressing the circumferential edge portion 41 of the workpiece W without colliding with the plurality of suction pads 251 even in a state in which the handler 250 presses the workpiece W against the workpiece stage 230 via the suction pads 251.

As described above, the workpiece holding mechanism 240 has a configuration in which the warpage correction mechanism 50 including the plurality of pushers 51, which is used in the workpiece holding mechanism 40 described in the above embodiment, is replaced with the handler 250 including the plurality of suction pads 251. This makes it possible to simultaneously perform warpage correction by the plurality of suction pads 251 and clamping by the clamp portion 271, and to reliably hold the workpiece W with respect to the workpiece stage 230.

Here, the operation of the workpiece holding mechanism 240 will be simply described. First, a workpiece W is suctioned by the handler 250 on a pre-alignment stage or the like on which the workpiece W is placed. At that time, the workpiece W is suctioned from the front side by the suction pads 251. Next, the handler 250 is moved to place the workpiece W on the workpiece stage 230. The steps so far correspond to Steps 101 and 102 shown in FIG. 8. As a result, similar to (2) of FIG. 9, the circumferential edge portion 41 of the workpiece W is pressed against the workpiece stage 230 by the suction pads 251, and the warpage of the workpiece W is corrected on the workpiece stage 230.

Next, the vacuum suction for the workpiece W by the workpiece stage 230 is started, and the clamp portion 271 is closed by the clamp mechanism 270. As described above, the clamp portion 271 is configured not to interfere with the suction pads 251, so that the clamp operation can be performed properly. Additionally, since the warpage of the workpiece W is corrected by the suction pads 251, the clamp portion 271 can reliably clamp the workpiece W. The steps so far correspond to Steps 103 and 104 shown in FIG. 8. As a result, similar to (3) of FIG. 9, the workpiece W is clamped by the clamp portion 271 with the warpage of the workpiece W being corrected by the suction pads 251.

Next, the handler 250 (suction pads 251) is retracted. In this case, the vacuum suction for the workpiece W by the suction pads 251 is released, and the handler 250 is then raised by the frame drive section 253. This step corresponds to Step 105 shown in FIG. 8. As a result, the handler 250 is retracted from the workpiece stage 230. Note that the workpiece W continues to be clamped by the clamp portion 271. This makes it possible to reliably vacuum-suction the workpiece W with respect to the workpiece stage 230. After the handler 250 is retracted, the exposure process or other processes are executed as appropriate.

In such a manner, also when the handler 250 including the suction pads 251 is used as a warpage correction mechanism, it is possible to achieve both the warpage correction by the suction pads 251 and the clamping by the clamp portion 271 by configuring the clamp portion 271 as appropriate. This makes it possible to reliably hold the workpiece W with respect to the workpiece stage 230 even in a system in which the upper surface of the workpiece W is suctioned to transport the workpiece W. Additionally, since the handler 250 serves as both the transport mechanism and the warpage correction mechanism, there is no need to provide a dedicated mechanism for correcting the warpage of the workpiece W, thereby reducing the cost of the apparatus.

### Other Embodiments

The present invention is not limited to the embodiments described above and can achieve various other embodiments.

In the embodiments described above, the case where a plate-like member provided with notches is used as a clamp portion has been described. The shape of the clamp portion is not limited to be plate-like. For example, a comb-like member may be used as the clamp portion, in which rods press the circumferential edge portion of a workpiece W at locations between a plurality of protrusions (pushers or suction pads). In this case, the clamp portion has a shape to partially press the workpiece W at multiple points by means of the tips of columnar rods or the like, instead of a plate surface. In such a manner, even if a comb-shaped clamp portion is used, it is possible to achieve both the warpage correction and the clamping of the workpiece W.

Additionally, in the embodiments described above, the configuration in which the plurality of protrusions (pushers or suction pads) are lowered to the workpiece stage to correct the warpage of the workpiece W has been described. However, for example, a configuration in which a workpiece stage is raised toward the plurality of protrusions may be adopted. In this case, the mechanism that raises the workpiece stage functions as a drive section that drives the plurality of protrusions (pressing mechanism).

In the embodiments described above, the workpiece stage is configured as a vacuum suction stage, but the workpiece stage does not necessarily vacuum-suction the workpiece W. Even in this case, the warpage of the workpiece W can be corrected by the plurality of protrusions, and the workpiece can be clamped by the clamp portion in that state. This makes it possible to hold the workpiece W in a state where the warpage is corrected without vacuum-suctioning the workpiece W.

The above embodiments have mainly described the exposure process of exposing the workpiece W, but the present invention is not limited thereto. The present invention can be applied to any processing performed with the flatness of the workpiece W being maintained. Examples of such processing include a film deposition process of generating a thin film, made of a metal material, a semiconductor material, a resin material, or the like, on the surface of a workpiece W, an etching process of scraping the surface of the workpiece W. Additionally, the present invention may also be applied to a workpiece stage used in machine processing, laser processing, or the like. In addition to the above, the type of processing is not limited.

At least two of the features among the features described above according to the present technology can also be combined. In other words, various features described in the embodiments may be combined discretionarily regardless of the embodiments. Further, the various effects described above are merely illustrative and not restrictive, and other effects may be exerted.

It should be understood by those skilled in the art that various modifications, combinations, sub-combinations and alterations may occur depending on design requirements and other factors insofar as they are within the scope of the appended claims or the equivalents thereof.

What is claimed is:

1. A workpiece holding mechanism, comprising:
a stage on which a plate-like workpiece is placed;
a pressing mechanism that includes a plurality of protrusions provided independently from the stage and disposed to come into contact with a circumferential edge portion of the workpiece from a front side of the workpiece, the front side being opposite to the stage, and presses the circumferential edge portion of the workpiece against the stage by the plurality of protrusions; and
a clamp mechanism that includes a clamp portion provided to the stage and configured to come into contact with the circumferential edge portion of the workpiece from the front side of the workpiece at a location between the protrusions without interfering with the plurality of protrusions, and presses the circumferential edge portion of the workpiece against the stage by the clamp portion.

2. The workpiece holding mechanism according to claim 1, wherein
the plurality of protrusions are columnar members having tip surfaces that come into contact with the front side of the workpiece or suction pads that suction the workpiece from the front side of the workpiece.

3. The workpiece holding mechanism according to claim 2, wherein
the plurality of protrusions are the columnar members, and
the columnar members each include a recessed structure provided to each tip surface.

4. The workpiece holding mechanism according to claim 2, wherein
the plurality of protrusions are the suction pads, and
the pressing mechanism is a handler that suctions and transports the workpiece by the suction pads.

5. The workpiece holding mechanism according to claim 1, wherein
the clamp portion is a plate-like member that includes notches formed to surround the plurality of protrusions, or a comb-like member that presses the circumferential edge portion of the workpiece by rods at locations between the plurality of protrusions.

6. The workpiece holding mechanism according to claim 1, wherein
the stage vacuum-suctions the workpiece.

7. The workpiece holding mechanism according to claim 1, wherein
the stage includes a seal member that is disposed to overlap with the circumferential edge portion of the workpiece, and
the plurality of protrusions press the circumferential edge portion of the workpiece against the stage from immediately above the seal member.

8. The workpiece holding mechanism according to claim 1, wherein
the pressing mechanism executes a first holding operation of pressing the circumferential edge portion of the workpiece against the stage by the plurality of protrusions, and
the clamp mechanism executes a second holding operation of pressing the circumferential edge portion of the workpiece against the stage by the clamp portion with the first holding operation being executed.

9. The workpiece holding mechanism according to claim 8, wherein
the pressing mechanism separates the plurality of protrusions from the workpiece with the second holding operation being executed.

10. The workpiece holding mechanism according to claim 1, wherein
the clamp mechanism includes
a contact component that constitutes at least a portion of the clamp portion, the portion coming into contact with the workpiece,
a mount portion on which the contact component is detachably mounted, and
a tentative fixing portion for clamp that tentatively fixes the contact component and the mount portion by a magnet.

11. The workpiece holding mechanism according to claim 1, wherein
the pressing mechanism includes
a support frame that supports the plurality of protrusions, and
a frame drive section that drives the support frame such that the plurality of protrusions press the workpiece.

12. The workpiece holding mechanism according to claim 11, wherein
the frame drive section includes a plate spring portion in which a restoring force acts in a direction orthogonal to the workpiece, and is connected to the support frame via the plate spring portion.

13. The workpiece holding mechanism according to claim 11, wherein
the support frame includes
a plurality of unit frames that support the plurality of protrusions in a row along the circumferential edge portion of the workpiece, and
a mount frame on which the plurality of unit frames are detachably mounted.

14. The workpiece holding mechanism according to claim 13, wherein
the support frame includes a tentative fixing portion for protrusion that tentatively fixes the plurality of unit frames and the mount frame by a magnet.

15. An exposure apparatus, comprising:
a workpiece holding mechanism including
a stage on which a plate-like workpiece is placed,
a pressing mechanism that includes a plurality of protrusions provided independently from the stage and disposed to come into contact with a circumferential edge portion of the workpiece from a front side of the workpiece, the front side being opposite to the stage, and presses the circumferential edge portion of the workpiece against the stage by the plurality of protrusions, and
a clamp mechanism that includes a clamp portion provided to the stage and configured to come into contact with the circumferential edge portion of the workpiece from the front side of the workpiece at a location between the protrusions without interfering with the plurality of protrusions, and presses the circumferential edge portion of the workpiece against the stage by the clamp portion; and
an exposure section that exposes a pattern onto the workpiece held by the stage.

16. A workpiece holding method of holding a plate-like workpiece on a stage on which the workpiece is placed, the method comprising:
executing a first holding operation of pressing a circumferential edge portion of the workpiece against the stage by a plurality of protrusions provided independently from the stage and disposed to come into contact with the circumferential edge portion of the workpiece from a front side of the workpiece, the front side being opposite to the stage; and
executing a second holding operation of pressing the circumferential edge portion of the workpiece against the stage by a clamp portion provided to the stage and configured to come into contact with the circumferential edge portion of the workpiece from the front side of the workpiece at a location between the protrusions without interfering with the plurality of protrusions with the first holding operation being executed.
